(19) United States
(12) Patent Application Publication
(10) Pub. No.: US 2026/0235150 A1
(43) Pub. Date: Aug. 13, 2026

(54) MOUNTING APPARATUS

(71) Applicant: Ahmet Resit CEVIRGEN, Istanbul (TR)

(72) Inventor: Ahmet Resit CEVIRGEN, Istanbul (TR)

(21) Appl. No.: 19/155,562

(22) PCT Filed: Feb. 26, 2024
(86) PCT No.: PCT/TR2024/050156

§ 371 Date: Aug. 12, 2025

(30) Foreign Application Priority Data
Mar. 1, 2023 (TR) 2023/002293

(51) Int. Cl. F16B 12/46

(52) U.S. Cl. CPC F16B 12/46

(57) ABSTRACT

A mounting apparatus is provided for joining the plates of enclosed volume articles, such as cases, crates, boxes, storage units, cabinets, and particularly cat and dog kennels, through the corner points and edge lines of said plates, in a way that allows the respective connections to be established in up to three axes.

### TECHNICAL FIELD

The present invention relates to a mounting apparatus for joining the plates of enclosed volume articles, such as cases, crates, boxes, storage units, cabinets, and particularly cat and dog kennels, through the corner points and edge lines of said plates, in a way that allows the respective connections to be established in up to three axes.

The present invention relates to a mounting apparatus for use in the installation of enclosed volume articles (referred to as enclosed volume in the remainder of the present specification), such as boxes, cases, cat and dog kennels, cargo crates, wardrobes, garden storage units, earthquake protection chambers, emergency living chambers, and the like.

### BACKGROUND ART

Cat and dog kennels are items that are constructed of a number of plates and assembled by means of nails, bolts, and other similar fasteners. Similarly, boxes, cases, cat and dog kennels, cargo crates, wardrobes, garden storage units, earthquake protection chambers, emergency living chambers, and other similar articles are also constructed of plates, and such plates are fastened to each other with nails, bolts and other similar components. The invention disclosed herein relates to a mounting apparatus for facilitating and stabilizing the installation of such enclosed volume articles.

In the known art, the enclosed volume articles are assembled and installed by means of nails, bolts and other similar fasteners. In this way, however, one cannot realize a durable structure, since fasteners used in the relevant mounting operation stretch the plates and damage the structure. Another disadvantage of this method is that it entails the person carrying out the mounting operation to have a level of craftsmanship which cannot be reasonably expected from every end-user. This is why manufacturers have to offer such products for sale in an already assembled form.

Another disadvantage of this mounting method used for the enclosed volume articles in the known art, which involves the use of bolts and other similar fastening members, is that said method cannot be applied to such plates having a thickness below 18 mm. In fact, even if this method is applied to such plates, one cannot provide a structure with durable connections as the wall thickness of said plates is too narrow to hold the bolts in place.

Although the sale of products in an already assembled form provides convenience to the user, this also results in an increase in storage, transportation and shipment costs. Therefore, there is a need for designs allowing the users to carry out the mounting and demounting process on their own.

### SUMMARY OF THE INVENTION

The present invention is a mounting apparatus that overcomes the drawbacks of the prior art, and also comprises further advantages.

An object of the present invention is to provide a mounting apparatus for enabling users to mount the plates of enclosed volume articles to each other through the corner and edge points of said plates without the need for craftmanship skills.

Another object of the present invention is to provide a mounting apparatus for enabling users to assemble an enclosed volume article in a durable form by allowing the respective connections to be established in up to three axes.

A further object of the present invention is to provide an mounting apparatus by means of which anyone can carry out the relevant mounting operation as said apparatus does not require any craftsmanship skills to use.

A further object of the present invention is to provide a mounting apparatus for allowing the enclosed volume articles to be delivered to users in an unassembled form.

Another object of the present invention is to provide a mounting apparatus which enables the mounting operation for enclosed volume articles to be carried out by holding them by their outer surfaces.

A further object of the present invention is to provide a mounting apparatus that can be used as a foot and/or an inner corner connection and/or an inner edge connection.

Another object of the present invention is to provide a novel mounting apparatus which is applicable to plates of any size, including plates of the thinnest thickness.

### BRIEF DESCRIPTION OF THE FIGURES

The invention will now be described by referring to the attached figures, whereby the features of the invention will be understood more clearly. However, it is not intended to limit the invention to these particular embodiments. On the contrary, it is aimed to involve all alternatives, modifications, and equivalents without departing from the scope of the present invention as defined in the attached claims. It should be noted that the details shown herein are only for illustrating the preferred embodiments of the present invention, and for providing the most useful and clear description of both the illustration of methods, and the principles and conceptual features of the present invention. In these drawings,

FIG.—1 is a perspective view of a mounting apparatus according to the present invention.

FIG.—2 is another perspective view of the mounting apparatus according to the present invention.

FIG.—3 is a bottom perspective view of the mounting apparatus according to the present invention.

FIG.—4 is a view showing the use of the mounting apparatus according to the present invention in an enclosed volume article.

The drawings, which are for ensuring a better understanding of the present invention, are numbered as shown in the attached figures, and the list and description of said numbers is given below.

### REFERENCE NUMERALS

10. Mounting apparatus
11. Horizontal attachment hole
12. Vertical attachment hole
13. Vertical reference platform
14. Rib
15. Horizontal channel
20. Enclosed volume article
21. Side plate
22. Bottom plate
23. Top plate

### DETAILED DESCRIPTION OF THE INVENTION

In this detailed description, a mounting apparatus (10) of the present invention is described by way of non-limiting examples in order to provide a better understanding of the subject-matter.

The mounting apparatus (10) of the present invention enables the respective connections to be established in up to three axes. It has the ability to mount two side plates (21), and one top plate (23) or bottom plate (22) to each other. For this purpose, it comprises a horizontal attachment hole (11) on each of its four lateral surfaces, as well as a vertical attachment hole (12) which is located in the middle of a vertical reference platform (13) centered between said lateral surfaces.

Each of the horizontal attachment holes (11) in the present invention comprises a horizontal channel (15) extending from a lateral surface of the mounting apparatus (10) to the vertical reference platform (13). Fasteners (bolts, nuts, screws) used for mounting the plates (21, 22, 23) of the enclosed volume article (20) to each other are guided through the horizontal channels (15) and up to the inner wall of the vertical reference platform (13). As a fastener advances in the horizontal channel (15), it either forms threads on the respective surface, or moves in an already threaded surface. The horizontal channels (15) increase the adhesion of the fasteners used.

The vertical reference platform (13) in the present invention increases the strength of the mounting apparatus and serves as a reference for the vertical attachment hole (12). The vertical reference platform (13) is attached to ribs (14) extending from the corners of the lateral surfaces of the mounting apparatus (10). Thus, its strength is increased.

The mounting apparatus (10) of the present invention is preferably in the form of a cube. This is to ensure that the plates can be mounted through the corners, edges, and other convenient sections thereof. Optionally, it can also be in the shape of a rectangular prism. Mounting apparatus (10) is made of a plastic material. It is manufactured by injection method. It can also be made of materials such as aluminum and zamak again by using the injection method.

The mounting apparatus (10) of the present invention allows the enclosed volume article (20) to be mounted from the outer surface of said article. In this way, the users will not face the installation difficulties they experience with the hard-to-access inner surface. In order to use the mounting apparatus (10), the side plates (21), the bottom plate (22) and the top plate (23) are required to be drilled in a precise manner. Such holes may be either already drilled on the plates, designated with a reference mark for drilling, or left to the user to drill. The mounting apparatus (10) and the plates (21, 22, 23) are mounted by means of fasteners. Said fasteners may be screws, bolts, and insert nuts, and instead of insert nuts, ready-made threaded rods obtained by injection molding can also be used.

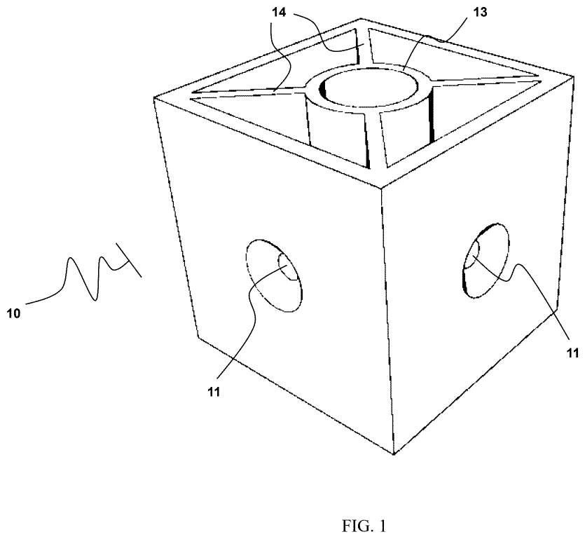

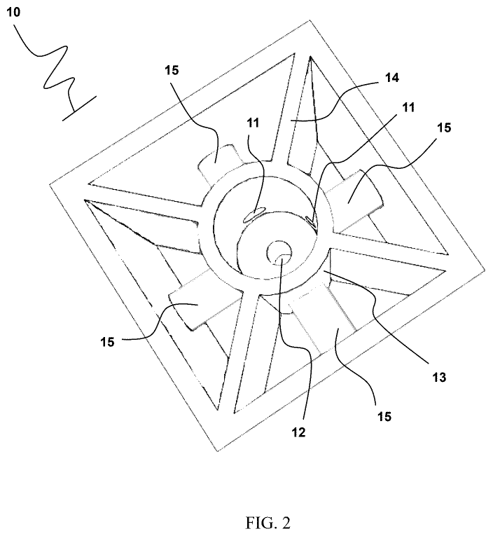

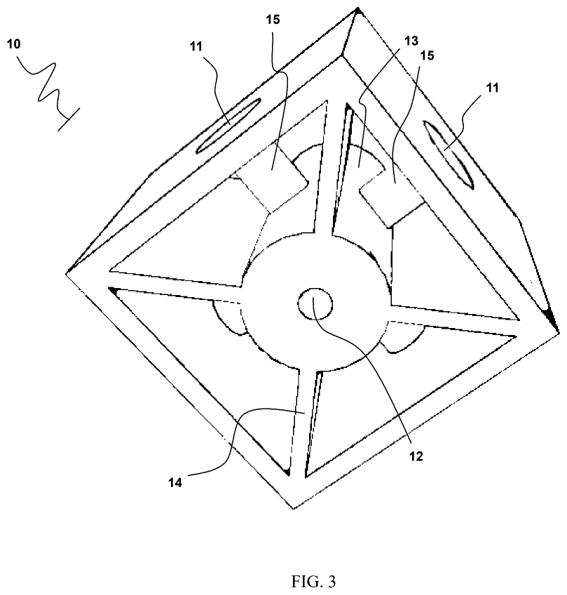

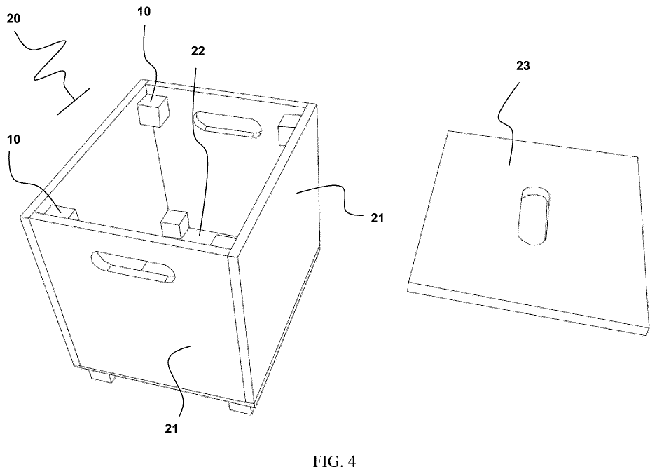

In practice, the mounting apparatus (10) of the present invention is attached to the bottom plate (22) via a fastener extending within the mounting apparatus (10) through the vertical attachment hole (12), and to the side plates (21) via fasteners extending from the outer surfaces of the side plates (21) through the horizontal attachment holes (11). Consequently, an enclosed volume product (20) as shown in FIG. 4 can be realized.

What is claimed is:

1. A mounting apparatus for joining plates of enclosed volume articles comprising cases, crates, boxes, storage units, cabinets, cat kennels, and dog kennels, through corner points and edge lines of the plates, allowing respective connections to be established in up to three axes, comprising:
horizontal attachment holes on four lateral surfaces of the mounting apparatus, wherein the horizontal attachment holes are configured to mount side plates by holding the side plates by outer surfaces of the side plates,
a vertical attachment hole for mounting a top plate or a bottom plate, wherein the vertical attachment hole is located in a middle of a vertical reference platform centered between the four lateral surfaces,
fasteners for attaching the horizontal attachment holes and the vertical attachment hole to the side plates, the top plate, and the bottom plate, and
horizontal channels for increasing adhesion of the fasteners and strength of the mounting apparatus, wherein the horizontal channels extend perpendicularly from the horizontal attachment holes located on the four lateral surfaces to the vertical reference platform.

2. The mounting apparatus according to claim 1, wherein in a central portion of the mounting apparatus, the vertical reference platform centers the vertical attachment hole and increases the strength of the mounting apparatus.

3. The mounting apparatus according to claim 1, further comprising ribs for increasing the strength of the mounting apparatus, wherein the ribs extend from corners of the four lateral surfaces of the mounting apparatus to the vertical reference platform.

4. The mounting apparatus according to claim 1, wherein the mounting apparatus is made of a plastic material.

5. The mounting apparatus according to claim 1, wherein the mounting apparatus is made of aluminum or zamak.

6. The mounting apparatus according to claim 1, wherein the fasteners comprise screws, bolts, and insert nuts or a ready-made threaded connecting element obtained by injection molding.

7. The mounting apparatus according to claim 1, further comprising an already threaded horizontal attachment hole or an already threaded vertical attachment hole or an already threaded horizontal channel.

8. The mounting apparatus according to claim 1, wherein the mounting apparatus is in a form of a cube or a rectangular prism.

9. (canceled)
